(19) United States
(12) Patent Application Publication
(10) Pub. No.: US 2013/0282540 A1
(43) Pub. Date: Oct. 24, 2013

(54) CLOUD COMPUTING CONSOLIDATOR BILLING SYSTEMS AND METHODS

(71) Applicant: Kris BLIESNER, Liberty Lake, WA (US)

(72) Inventor: Kris BLIESNER, Liberty Lake, WA (US)

(73) Assignee: 2ND WATCH, INC., Suite 103 Liberty Lake, WA (US)

(21) Appl. No.: 13/865,952

(22) Filed: Apr. 18, 2013

Related U.S. Application Data
(60) Provisional application No. 61/635,778, filed on Apr. 19, 2012.
(60) Provisional application No. 61/642,332, filed on May 3, 2012.

(51) Int. Cl. G06Q 20/14

(52) U.S. Cl. CPC G06Q 20/145
USPC 705/34

(57) ABSTRACT

A consolidated bill for commodity computing services may be unconsolidated by obtaining periodic usage statistics corresponding to computing-commodity usage specific to each entity whose consumption is included in the consolidated bill. Based at least in part on the usage statistics and on one or more entity-specific discount entitlements, a discounted billing rate that is applicable to at least some of an entity's usage can be determined, as can a non-discounted billing rate. Using the determined statistics and billing rates, an unblended cost for each entity's specific commodity usage can be computed and stored for subsequent presentation to each entity and/or for further processing.

### CROSS REFERENCE TO RELATED APPLICATIONS

This application claims the benefit of priority to the following U.S. Provisional Patent Applications:
No. 61/635,778; titled “CLOUD COMPUTING CONSOLIDATOR BILLING SYSTEMS AND METHODS”; filed Apr. 19, 2012 under Attorney Docket No. 2NDW-2012003; and naming inventor Kris Bliesner; and
No. 61/642,332; titled “CLOUD COMPUTING CONSOLIDATOR BILLING SYSTEMS AND METHODS”; filed May 3, 2012 under Attorney Docket No. 2NDW-2012002; and naming inventor Kris Bliesner.
   Each of the above-cited applications is incorporated herein by reference in its entirety, for all purposes.

### FIELD

This disclosure is directed to cloud computing. More particularly, this disclosure is directed to providing billing services for resellers of cloud computing commodities.

### BACKGROUND

“Cloud computing” refers to the delivery of computing as a service rather than a product, whereby shared resources, software, and information are provided to computers and other devices as utility or commodity services over a network (typically the Internet). For example, Amazon Web Services (“AWS”), provided by Amazon.com, Inc. of Seattle, Wash., includes Amazon Elastic Compute Cloud (“EC2”), which provides commodity computing capacity; Amazon Simple Storage Service (“S3”), which provides commodity data storage and retrieval services; Amazon SimpleDB, which provides commodity non-relational database services; and many other similar commodity computing services. Many other cloud commodity services exist, including Google App Engine, provided by Google Inc. of Mountain View, Calif.; Heroku, provided by Heroku, Inc. of San Francisco, Calif.; Windows Azure Platform, provided by Microsoft Corporation of Redmond, Wash.; and the like.

Generally, such cloud computing providers use a pay-per-use pricing structure based on units of capacity (e.g. computing capacity, storage capacity, data access capacity, and the like) that are billed according to usage and/or capability tiers. For example, a storage-commodity provider might charge $1× per month for the first terabyte of storage, $0.9× per terabyte/month for the next 49 terabytes; $0.75× for the next 450 terabytes/month; and so on. A storage-commodity provider may also charge for inbound and/or outbound data transfer (e.g., $1× per gigabyte per month for the first 10 terabytes of data transfer; $0.9×per gigabyte/month for the next 40 terabytes; and so on) and/or for other billable units of capacity.

Similarly, a computing-commodity provider may charge by the hour for running a computing instance having a given set of capabilities (e.g., a standard rate of $1×per hour for a minimally capable computing instance, $2×per hour for a moderately capable computing instance, $4×per hour for a highly capable computing instance, and so on).

Some computing-commodity services allow a given customer account to purchase discounted rates for a period of time. For example, an Amazon EC2 customer may purchase for an upfront fee a “reserved instance” entitling that customer to discounted hourly rates for a fixed term of one to three years (e.g., a discounted rate of $0.5×per hour for a minimally capable computing instance, $1×per hour for a moderately capable computing instance, $2×per hour for a highly capable computing instance, and so on). In some cases, higher discounts may be purchased for higher upfront fees.

Some cloud computing services (e.g., AWS) may also allow multiple related accounts to be consolidated for billing purposes. For example, at a given company, the sales and IT departments may each have their own accounts with a cloud computing provider. On a consolidated bill for the company as a whole, the usage rates for a given commodity may be determined based on the aggregate utilization of both departments. For commodities whose cost per unit decreases with increased utilization (e.g., as in the storage-commodity pricing discussed above), such consolidation may result in lower costs for the departments and the company than if the departments were billed individually.

Similarly, a cloud-service reseller may obtain a consolidated bill aggregating computing-commodity usage across all of the reseller's client accounts.

However, in some cases, consolidated billing can also raise the cost for accounts that have purchased reserved instances or other such pre-paid discounted services. For one simple example, consider the case in which account “A” has purchased two discounted instances entitling account A to pay $0.05 per hour for computing server commodity “X” (e.g., a server running a given operating system, in a given geographical region, with a given amount of memory, storage, bandwidth, and the like), and account “B” has purchased zero discounted computing instances entitling account B to pay $0.10 per computing hour for the same computing server commodity X. Consider also that during a given hour on a given day, account A and account B are each running two instances of computing server commodity X.

If account A and account B received individual bills, then account A would pay $0.05 per instance during the given hour for its usage of commodity X because there are two instances of commodity X running for the account being billed (account A) and there are two discounted instances available to the account being billed (account A). Similarly, on an individual bill, account B would pay $0.10 per instance during the given hour for its usage of commodity X because there are two instances of commodity X running for the account being billed (account B) and there are zero discounted instances available to the account being billed (account B).

However, if accounts A and B are consolidated onto the same bill (e.g., because they are both departments of the same company, or because they both purchased the computing commodity from the same reseller), then accounts A and B would pay on average $0.075 per instance during the given hour for their usage of commodity X because there are four instances of commodity X running across the accounts being billed (accounts A and B) and there are only two discounted instances available across the accounts being billed (accounts A and B). Consequently, half of the instances of commodity X are billed at the standard rate, and half at the discounted rate, costing accounts A and B $0.075 on average.

Thus, in the simple exemplary scenario, the consolidated bill deprives account A of some of the benefit of the discounted instances that it purchased in cases where both of accounts A and B are running simultaneous instances of commodity X.

### BRIEF DESCRIPTION OF THE DRAWINGS

FIG. 1 illustrates a simplified cloud computing system in which cloud consolidator server, consolidator-linked-account clients, cloud-computing-services provider, and computing-commodity servers are connected to network.

FIG. 2 illustrates several components of an exemplary cloud consolidator server.

FIG. 3 illustrates a routine for re-billing consolidated accounts, such as may be performed by cloud consolidator server in accordance with one embodiment.

FIG. 4 illustrates a subroutine for computing an account-group-specific cost for a given utilization of a given computing commodity during a given time period, such as may be performed by cloud consolidator server in accordance with one embodiment.

FIG. 5 illustrates a routine for automatically purchasing discount entitlements based on a consolidated bill, such as may be performed by cloud consolidator server in accordance with one embodiment.

FIGS. 6-9 illustrates several user interfaces and/or reports that may be provided for and/or presented to a user in accordance with various embodiments.

### DESCRIPTION

The detailed description that follows is represented largely in terms of processes and symbolic representations of operations by conventional computer components, including a processor, memory storage devices for the processor, connected display devices and input devices. Furthermore, these processes and operations may utilize conventional computer components in a heterogeneous distributed computing environment, including remote file Servers, computer Servers, and memory storage devices. Each of these conventional distributed computing components is accessible by the processor via a communication network.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications, and equivalents. In alternate embodiments, additional devices, or combinations of illustrated devices, may be added to, or combined, without limiting the scope to the embodiments disclosed herein.

As used herein, the terms “discounted instance” and “term-based discount entitlements” refer to commodity units that are entitled to discounted billing rates for a fixed term in exchange for payment of an upfront fee, as opposed to billing tiers that vary according to usage quantity and/or capability. Rather, billing rates that may vary according to usage quantity and/or capability, but that are not based on fixed-term, upfront-fee discount entitlements, are referred to as “standard” billing rates.

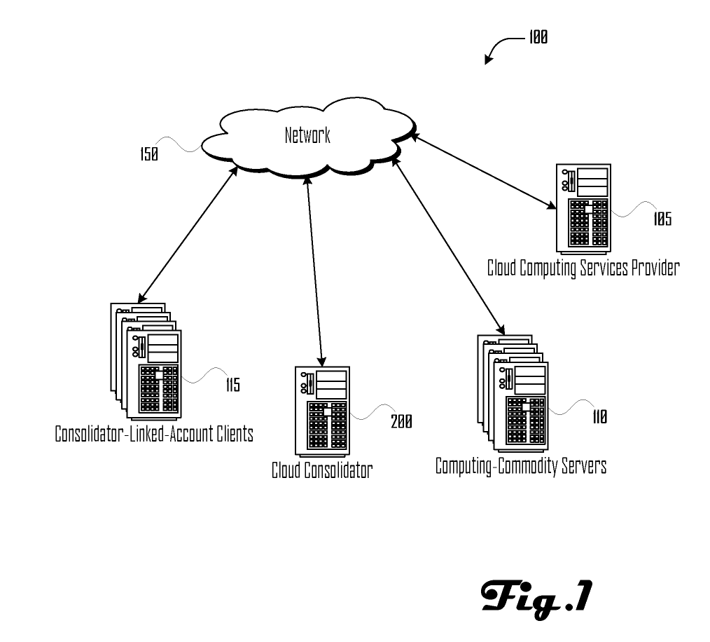

FIG. 1 illustrates a simplified cloud computing system in which cloud consolidator server 200, consolidator-linked-account clients 115, cloud-computing-services provider 105, and computing-commodity servers 110 are connected to network 150. Typically, cloud consolidator server 200 is operated by a reseller or other middleman entity that pays for cloud-computing services from cloud-computing-services provider 105 on behalf of clients 115, whose cloud-computing accounts are “linked” to the consolidator's account. Furthermore, cloud-computing-services provider 105 typically operates computing-commodity servers 110, which provide commodities such as computing capacity, storage capacity, data access capacity, and the like, to consolidator-account clients 115.

In various embodiments, network 150 may include the Internet, a local area network (“LAN”), a wide area network (“WAN”), and/or other data network.

In various embodiments, additional infrastructure (e.g., cell sites, routers, gateways, firewalls, and the like), as well as additional client and server devices may be present. Further, in some embodiments, the functions described as being provided by some or all of cloud consolidator server 200 may be implemented via various combinations of physical and/or logical devices. However, it is not necessary to show such infrastructure and implementation details in FIG. 1 in order to describe an illustrative embodiment.

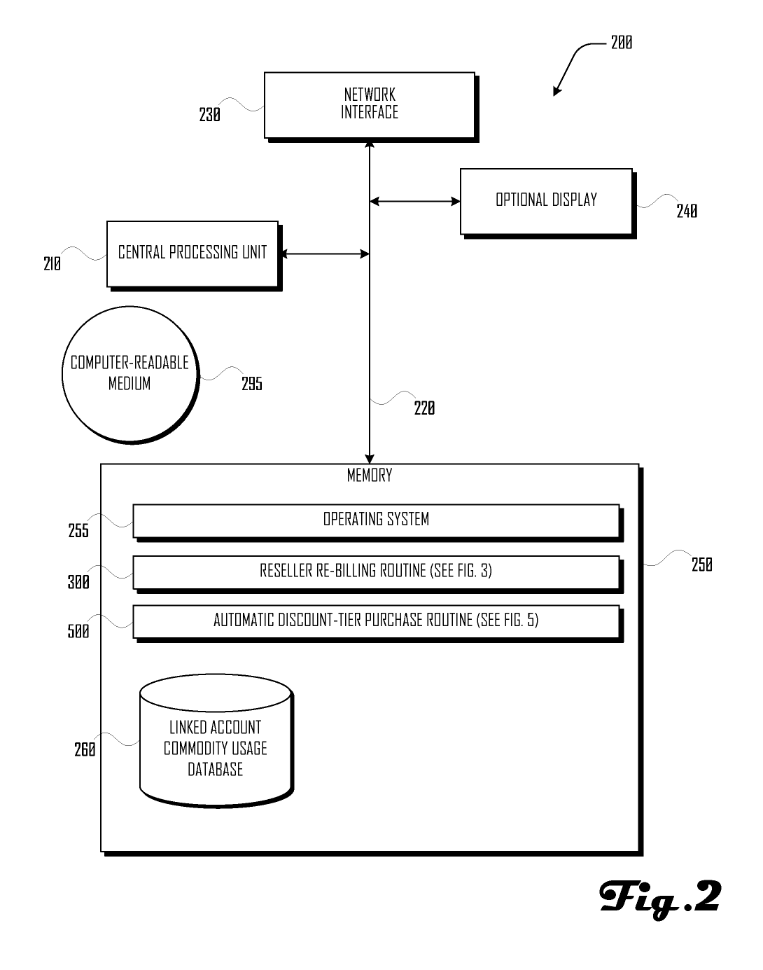

FIG. 2 illustrates several components of an exemplary cloud consolidator server 200. In some embodiments, cloud consolidator server 200 may include many more components than those shown in FIG. 2. However, it is not necessary that all of these generally conventional components be shown in order to disclose an illustrative embodiment. As shown in FIG. 2, cloud consolidator server 200 includes a data network interface 230 for connecting to network 150.

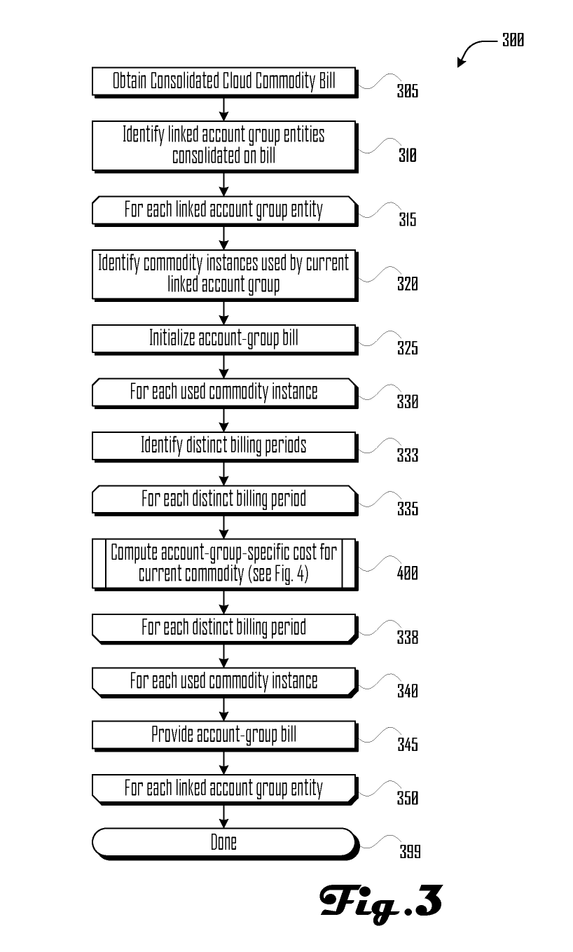

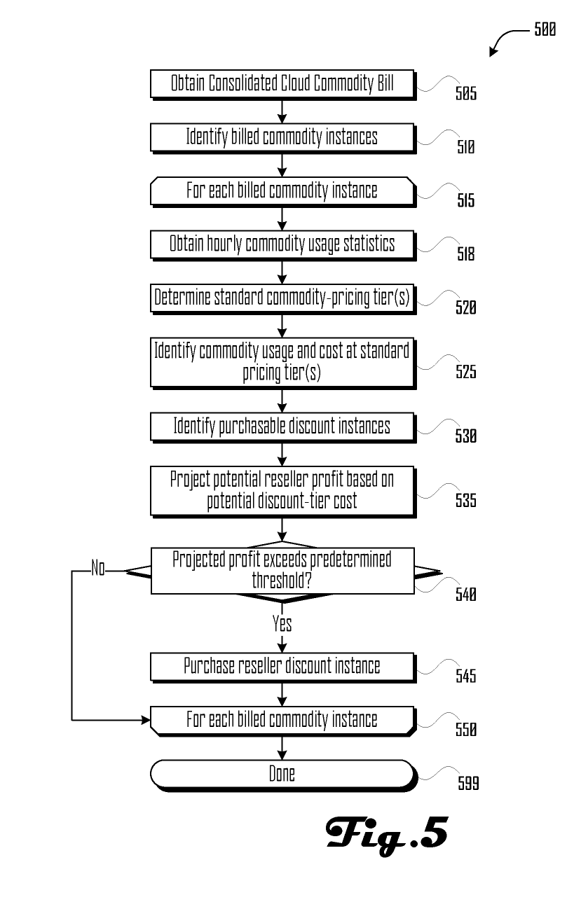

Cloud consolidator server 200 also includes a processing unit 215, a memory 250, and an optional display 240, all interconnected along with the network interface 230 via a bus 220. The memory 250 generally comprises a random access memory (“RAM”), a read only memory (“ROM”), and a permanent mass storage device, such as a disk drive. The memory 250 stores program code for routine 300 for re-billing consolidated accounts (see FIG. 3), and routine 500 for automatically purchasing discount entitlements based on a consolidated bill (see FIG. 5).

In addition, the memory 250 also stores an operating system 255 and commodity-usage database 260 (and/or routines for access to such an external database). These and other software components may be loaded from a non-transitory, tangible computer readable storage medium 295 into memory 250 of the cloud consolidator server 200 using a drive mechanism (not shown) associated with a non-transitory computer readable storage medium 295, such as a floppy disc, tape, DVD/CD-ROM drive, flash card, memory card, or the like. In some embodiments, software components may also be loaded via the network interface 230, rather than via a computer readable storage medium 295.

Although cloud consolidator server 200 has been described as a conventional computing device, in other embodiments, cloud consolidator server 200 may include other computing devices capable of communicating with network 150 such as a mobile phone, computing tablet, set-top box, or other like device.

FIG. 3 illustrates a routine 300 for re-billing consolidated accounts, such as may be performed by cloud consolidator server 200 in accordance with one embodiment. In block 305, routine 300 obtains a consolidated bill for cloud computing commodities utilized by a plurality of clients whose accounts are linked to the cloud consolidator. For example, in one embodiment, the consolidated bill may include data such as that shown in Table 1, which shows usage and pricing for a “standard small instance” computing commodity (which is billed per hours of usage) as used by accounts 9976, 0777, 3149, 4565, and 5221 (all of which are linked to the cloud consolidator's account).

TABLE 1
Portion of consolidated bill for a given consolidator and billing period

| Linked | Commodity | Commodity | Usage | Unit | |
|---|---|---|---|---|---|
| Account Id | Name | Description | Amount | Price | Cost |
| 9976 | Compute | Standard Small | 696 | $0.0564 | $39.26 |
| | Cloud | Instance-hours | | | |
| | | used this month | | | |
| 0777 | Compute | Standard Small | 767 | $0.0564 | $43.26 |
| | Cloud | Instance-hours | | | |
| | | used this month | | | |
| 3149 | Compute | Standard Small | 196 | $0.0564 | $11.06 |
| | Cloud | Instance-hours | | | |
| | | used this month | | | |
| 4565 | Compute | Standard Small | 1393 | $0.0564 | $78.57 |
| | Cloud | Instance-hours | | | |
| | | used this month | | | |
| 5221 | Compute | Standard Small | 888 | $0.0564 | $50.09 |
| | Cloud | Instance-hours | | | |
| | | used this month | | | |

The “unit price” illustrated in Table 1 represents the unit price to which the cloud consolidator is entitled, based on usage and/or discount tiers across all of the accounts that are linked to the cloud consolidator. For example, in the example illustrated in Table 1, the cloud-computing services provider may charge numerous different rates for a standard small instance, the exemplary rates varying from $0.115/hour (no discount) to $0.059/hour (one-year light-utilization reserved instance discount tier) to $0.033/hour (three-year heavy-utilization reserved instance discount tier). Thus, the $0.0564/hour unit price on the consolidated bill represents a blended rate determined based on discount tiers and other factors that are not itemized in the consolidated bill.

However, as discussed above, the unit price (and corresponding “cost”) shown on the consolidated bill does not necessarily reflect the unit price (and corresponding cost) to which the individual linked accounts should be entitled. Moreover, it may be impossible or difficult to determine appropriate linked-account billing rates based only on the information included in the consolidated bill (which may not itemize the discount tiers and other factors on which the $0.0564/hour blended rate was based).

In block 310, routine 300 identifies a plurality of “account group” entities. As used herein, an “account group” entity refers to one or more linked accounts whose commodity usage is consolidated on the consolidated bill. In some embodiments, an account group entity may consist of an individual linked account (as identified in the “Linked Account ID” column of Table 1). In other embodiments, two or more or the individual linked accounts may be grouped together for re-billing purposes. For example, in the exemplary embodiment described herein, account IDs 9976 and 0777 might both be associated with a single entity (e.g., account ID 9976 might be associated with department A of company X, and account ID 0777 with department B of company X). Consequently, account IDs 9976 and 0777 may be identified as belonging to a single account group entity in block 310.

Beginning in opening loop block 315, routine 300 processes each account group in turn. In block 320, routine 300 identifies one or more commodity instances that were utilized by members of the current account group and billed on the consolidated bill. For example, the exemplary consolidated bill portion shown in Table 1 shows that members of various account groups utilized a “Standard Small Instance” of a “Compute Cloud”. In many embodiments, a consolidated bill may include many additional commodities (not shown), such as other compute cloud instances, storage instances, database instances, and so on.

In block 325, routine 300 initializes a data structure from which an account-group specific bill can be populated, as discussed further below.

Beginning in opening loop block 330, routine 300 processes in turn each commodity instance identified in block 320. In block 333, routine 300 identifies one or more distinct billing periods during which the current account group utilized the current commodity instance. For example, in one embodiment, the consolidated bill may cover multiple months (or other calendar period), each of which is identified as a distinct billing period in block 333. In another embodiment, the commodity provider (e.g., cloud-computing-services provider 105) may have changed its rates from an original rate to a modified rate for the current commodity during the period of time covered by the consolidated bill. In such case, the period covered by the original rate may be treated as a distinct billing period, as may be the period covered by the modified rate.

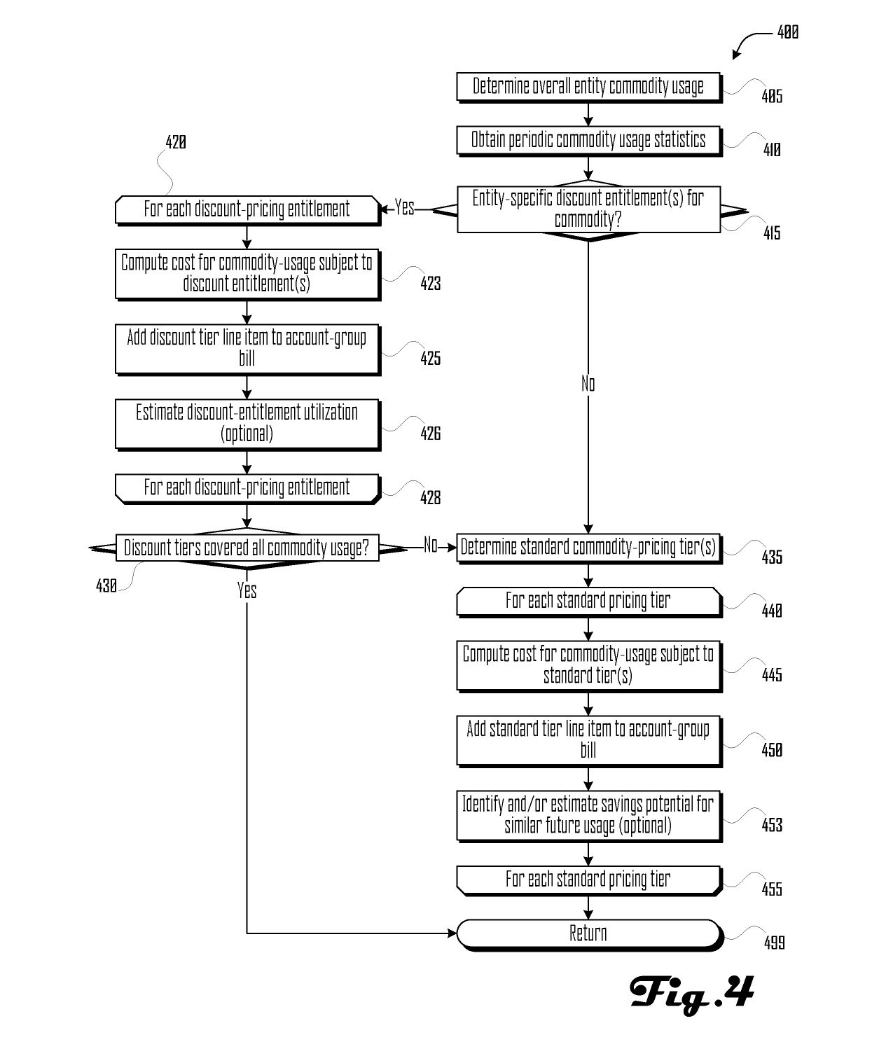

In subroutine block 400, routine 300 calls subroutine 400 (see FIG. 4, discussed below) to compute a cost for the current commodity instance that is specific to the current account group entity's commodity usage and discount entitlements (if any) for the current billing period.

In closing loop block 338, routine 300 iterates back to block 333 to process the next distinct billing period (if any). Once all distinct billing periods have been processed, in closing loop block 340, routine 300 iterates back to block 330 to process the next commodity instance (if any).

Once account-specific costs have been computed for each commodity instanced used by members of the current account group, in block 345 routine 300 assembles and provides an account-group-specific bill to a user and/or entity associated with the current account group. For example, in an exemplary embodiment, account-group specific bills for various linked accounts may include line items such as those shown in Table 2, reflecting a scenario in which linked account ID 9976 had purchased a discounted instance that covered all of its commodity usage, and all other accounts paid standard rates.

TABLE 2
Re-billed account-specific line-items

| Linked | Commodity | Commodity | Usage | Unit | |
|---|---|---|---|---|---|
| Account Id | Name | Description | Amount | Price | Cost |
| 9976 | Compute | Standard Small | 696 | $0.033 | $22.97 |
| | Cloud | Instance-hours | | | |
| | | used this month | | | |
| 0777 | Compute | Standard Small | 767 | $0.115 | $88.21 |
| | Cloud | Instance-hours | | | |
| | | used this month | | | |
| 3149 | Compute | Standard Small | 196 | $0.115 | $22.54 |
| | Cloud | Instance-hours | | | |
| | | used this month | | | |
| 4565 | Compute | Standard Small | 1393 | $0.115 | $160.20 |
| | Cloud | Instance-hours | | | |
| | | used this month | | | |
| 5221 | Compute | Standard Small | 888 | $0.115 | $102.12 |
| | Cloud | Instance-hours | | | |
| | | used this month | | | |

In closing loop block 350, routine 300 iterates back to block 315 to process the next account group (if any). Once all account groups have been processed, routine 300 ends in block 399.

FIG. 4 illustrates a subroutine 400 for computing an entity-specific cost for a given utilization of a given computing commodity during a given time period, such as may be performed by cloud consolidator server 200 in accordance with one embodiment.

In block 405, subroutine 400 determines an overall amount of usage of the given computing commodity across all members of the given account group. For example, when given a Standard Small Instance Compute Cloud Commodity and an account group consisting of account IDs 9976 and 0777 (as shown in Table 1), subroutine 400 may determine that across all members of the account group, 1463 hours of the commodity were utilized across the group. Similarly, when given a group consisting of account ID 3149, subroutine 400 may determine that 196 hours of the commodity were utilized across the group.

In block 410, subroutine 400 obtains periodic (e.g., hourly) usage statistics for the given time period, account group, and commodity. In some embodiments, such periodic usage statistics may be available via an application programming interface (“API”) provided by the commodity provider (e.g., cloud-computing-services provider 105). In some embodiments, the commodity provider may bill for certain commodity usage in hourly increments. In such embodiments, hourly usage statistics may be obtained. For explanatory purposes, “hourly” statistics are referred to below, but in other embodiments, if a commodity provider bills according to a different periodic increment, periodic usage statistics with a period other than an hour may be employed

In other embodiments, the commodity provider may provide such hourly usage statistics only for very recent time periods (e.g., the past day or week). In such embodiments, cloud consolidator server 200 may periodically (e.g., once per hour, once or several times per day or week, or the like) collect recent hourly usage statistics for all linked accounts from the commodity provider using an API provided for such a purpose. In some embodiments, if no such API is available or if available APIs provide insufficient data, cloud consolidator server 200 may replace or supplement the API-provided data with data extracted from reports provided by the commodity provider for human interpretation. For example, in one embodiment, cloud consolidator server 200 may use “web scraping” techniques for extracting hourly usage statistics for a given linked account from reports provided in HyperText Markup Language (“HTML”), eXtensible HyperText Markup Language (“XHTML”) or the like.

In cases in which cloud consolidator server 200 periodically collects recent hourly usage statistics for all linked accounts from the commodity provider, cloud consolidator server 200 may store the collected hourly usage statistics for some or all linked-accounts in commodity-usage database 260 for subsequent retrieval by subroutine 400 in block 310.

In decision block 415, subroutine 400 determines whether one or more discounted-pricing entitlements are available to the given account group. For example, one or more of the accounts in the group may have purchased a reserved instance or other discounted instance entitling the account group to discounted pricing for some or all of its commodity usage during the given billing period.

If subroutine 400 determines in decision block 415 that one or more discounted-pricing entitlements are available to the given account group, then in opening loop block 420, subroutine 400 processes each determined discount pricing entitlement in turn.

In block 423, using the hourly usage statistics obtained in block 410, subroutine 400 determines the amount of commodity usage subject to the current discount pricing tier and computes a cost for that usage accordingly. For example, when processing a discounted instance purchased by an account group consisting of account ID 4565 (as shown in Table 1), subroutine 400 may determine that the 696 usage hours reported on the consolidated bill arose from a single computing instance running for 29 days, indicating that all 696 usage hours are entitled to the discount pricing tier. Similarly, if subroutine 400 determined that the 696 usage hours reported on the consolidated bill arose from any number of computing instances running sequentially, one at a time, for 29 days, then all 696 usage hours would also be entitled to the discount pricing tier. At the other extreme, the hourly usage statistics may indicate that the 696 usage hours arose from 696 computing instances running simultaneously for one hour each, indicating that only 1 of the 696 usage hours is entitled to the discount pricing tier.

Having determined an appropriate cost for the commodity-usage subject to the current discount tier, in block 425, subroutine 400 adds that cost as a line item to the account-group-specific bill data structure initialized in block 325 (discussed above in reference to FIG. 3).

In some embodiments, in block 426, subroutine 400 may perform additional processing to the current discount entitlement. For example, in one embodiment, subroutine 400 may determine statistics that may assist a cloud consolidator to determine whether a given discount entitlement has provided a return on the investment that was required to acquire the entitlement. In other words, in a simplified example, a reserved instance that costs $100 to acquire may be considered to provide a return once the reserved instance has been utilized for a sufficient number of hours that it has provided more than $100 in discounts. In that sense, a reserved instance (or similar discount entitlement) may be considered to be “profitable” when the benefits derived from the reserved instance exceed the costs associated with acquiring and/or maintaining the reserved instance.

To such ends, in various embodiments, subroutine 400 may determine data such as an acquisition date and/or an acquisition cost of the current discount entitlement, as well as cumulative statistics describing the discount entitlement's performance since its acquisition. In some embodiments, determining a discount entitlement's performance may include determining how many units of a computing commodity were entitled to the discount, determining a “rack rate”, standard rate, or other non-discounted rate at which those units of commodity would have been billed in the absence of the discount entitlement, and determining a difference between the standard rate and the discounted rate for those units of commodity.

In other embodiments, subroutine 400 may determine additional discount-entitlement statistics such as counting billing periods during which the discount entitlement was not utilized or other similar methods of determining whether a discount entitlement was “spoiled” or under-utilized for some period of time.

In closing loop block 430, subroutine 400 iterates back to block 420 to process the next discount pricing tier determined in block 415 (if any).

Having processed all discounted-pricing entitlements, in decision block 430, subroutine 400 determines whether all of the commodity usage was covered by one or more discount pricing tiers (and therefore, whether all of the commodity usage is reflected in the account-group-specific bill data structure). If so, then subroutine ends in block 499, returning to the caller, having populated the account-group-specific bill data structure with cost items for all commodity usage.

However, if there remains commodity usage that was not subject to a discount-pricing entitlement, then in block 435, subroutine 400 determines one or more standard pricing tiers or other such non-discounted rate for the given commodity during the given time period. For example, in the explanatory embodiment, there may be one standard pricing tier for the standard small instance commodity: $0.115/hour. In other embodiments, there may be multiple standard tiers for a given commodity—e.g., $0.125/GB for the first 1TB of storage/month, $0.11/GB for the next 49TB of storage/month, $0.095/GB for the next 450TB of storage/month, and so on. In various embodiments, such standard pricing tiers may be published by and/or available from cloud-computing-services provider 105, and subroutine 400 may periodically obtain and cache such standard pricing tiers (not shown).

Beginning in opening loop block 440, subroutine 400 processes each standard pricing tier in turn. In block 445, subroutine 400 uses the periodic usage statistics obtained in block 410 to compute the cost for any commodity usage determined to be subject to the current standard pricing tier. In block 450, subroutine 400 adds that cost as a line item to the account-group-specific bill data structure initialized in block 325 (discussed above in reference to FIG. 3) and updated in block 425 (if one or more discount tiers was processed).

In some embodiments, in block 453, subroutine 400 may further process the commodity usage that is subject to the current standard-pricing tier to, for example, identify and/or estimate whether future commodity usage that is similar to the current commodity usage patterns could be obtained at more advantageous pricing. For example, in one embodiment, subroutine 400 may determine that it may be advantageous to purchase a reserved instance or other discount entitlement if the cost of the standard-priced commodity usage exceeds some percentage (e.g., 25%, 33%, or the like) of the cost of acquiring a reserved instance or other discount entitlement.

In other embodiments, subroutine 400 may determine whether the standard-priced commodity usage could be moved to a different, but similar, class of service without materially impairing the functionality provided by the commodity usage.

For example, AWS reserved instances are classified according to various parameters, such as operating system, geographic region, and capabilities (often referred to as “size”, where “larger” classes are faster, have more memory, and/or are otherwise more capable than “smaller” classes). In many cases, it would be difficult to switch computing commodity usage from one operating system to another. In many cases, functionality may be impaired by switching from a more capable or “larger” class of service to a less capable or “smaller” class. And in some cases, switching computing commodity usage from one geographic region to another may impact certain functionality and/or availability goals.

However, in most cases, the functionality provided by commodity usage would not be materially impaired by switching from a less capable class of computing commodity usage to a more capable class of the same service (e.g., with the same operating system and in the same geographic region). In other words, it would rarely materially impede performance to switch a computing operation from a “small” instance to a “medium” or “large” instance, keeping all other parameters identical.

Ordinarily, more-capable instances are more expensive per unit to operate than less-capable instances, so it generally makes sense to provision a given service on the smallest instance that can meet the desired specifications for performance, reliability, and the like. However, it is also sometimes the case that a reserved instance (or other discount entitlement) of size X may be less expensive than a standard, non-reserved instance of size X-1 or even X-2 (i.e., a reserved “large” instance may cost less to operate than a non-reserved “medium” or even “small” instance).

As a result, in the case where (for example) there is an under-utilized “medium” reserved instance that is identical to a non-reserved “small” instance, it may actually be less expensive to move a service from the “small” instance to the reserved “medium” instance. In some embodiments, subroutine 400 may identify and/or estimate potential savings that may be available by making immaterial modifications such as re-provisioning certain commodity usage to make more efficient use of available discount entitlements.

In ending loop block 455, subroutine 400 iterates back to block 435 to process the next standard pricing tier (if any). Having processed all commodity usage, subroutine ends in block 499, returning to the caller, having populated the account-group-specific bill data structure with cost items for all commodity usage.

FIG. 5 illustrates a routine 500 for automatically purchasing discount tiers based on a consolidated bill, such as may be performed by cloud consolidator server 200 in accordance with one embodiment. In block 505, routine 500 obtains a consolidated bill for cloud computing commodities utilized by a plurality of clients whose accounts are linked to the cloud consolidator. For example, in one embodiment, the consolidated bill may include data such as that shown in Table 1, which shows usage and pricing for a “standard small instance” computing commodity.

In block 510, routine 500 identifies one or more commodity instances that were utilized by members of a linked account and billed on the consolidated bill. Beginning in opening loop block 515, routine 500 processes in turn each commodity instance identified in block 510.

In block 518, routine 500 obtains hourly usage statistics for the time period covered by the consolidated bill, the linked account groups billed on the consolidated bill, and the current commodity. (See discussion of block 410 in reference to FIG. 4, above.)

In block 520, routine 500 determines one or more standard pricing tiers for the given commodity during the time period covered by the consolidated bill. (See discussion of block 435 in reference to FIG. 4, above.)

Using the hourly usage statistics obtained in block 518, in block 525, routine 500 identifies any usage of the current commodity on the consolidated bill that is billed according to a standard pricing tier(s) (i.e., usage that is not subject to a term-based discount instance purchased by one of the account groups and/or by the consolidation entity that operates cloud consolidator server 200), and routine 500 determines a cost associated with the current commodity at the standard pricing tier(s).

In block 530, routine 500 identifies one or more term-based discount instances or entitlements that would apply to the commodity usage identified in block 525. In block 535, routine 500 compares the standard-tier cost to the cost of purchasing a discount instance to obtain a discount pricing tier for the same commodity usage and projects potential future profits that could be obtained by the reseller if the reseller purchased the identified discount instance. In some embodiments, such profit may arise because the reseller may continue to bill the account groups in question at the standard pricing tier, while paying the commodity provider (e.g., cloud-computing-services provider 105) on the discounted tier. In some embodiments, the profit projection may account for the possibility that one or more of the account groups may also decide to purchase their own discount instances.

In decision block 540, routine 500 determines whether the projected profit exceeds a predetermined threshold. If not, then in closing loop block 550, routine 500 iterates back to block 515 to process the next commodity instance (if any). On the other hand, if routine 500 determines that the projected profit exceeds the predetermined threshold, then in block 545, routine 500 automatically purchases the discount instance from the commodity provider (e.g., cloud-computing-services provider 105). In other embodiments, instead of automatically purchasing the discount instance, routine 500 may provide an alert or report on which another agent can act.

Routine 500 ends in block 599.

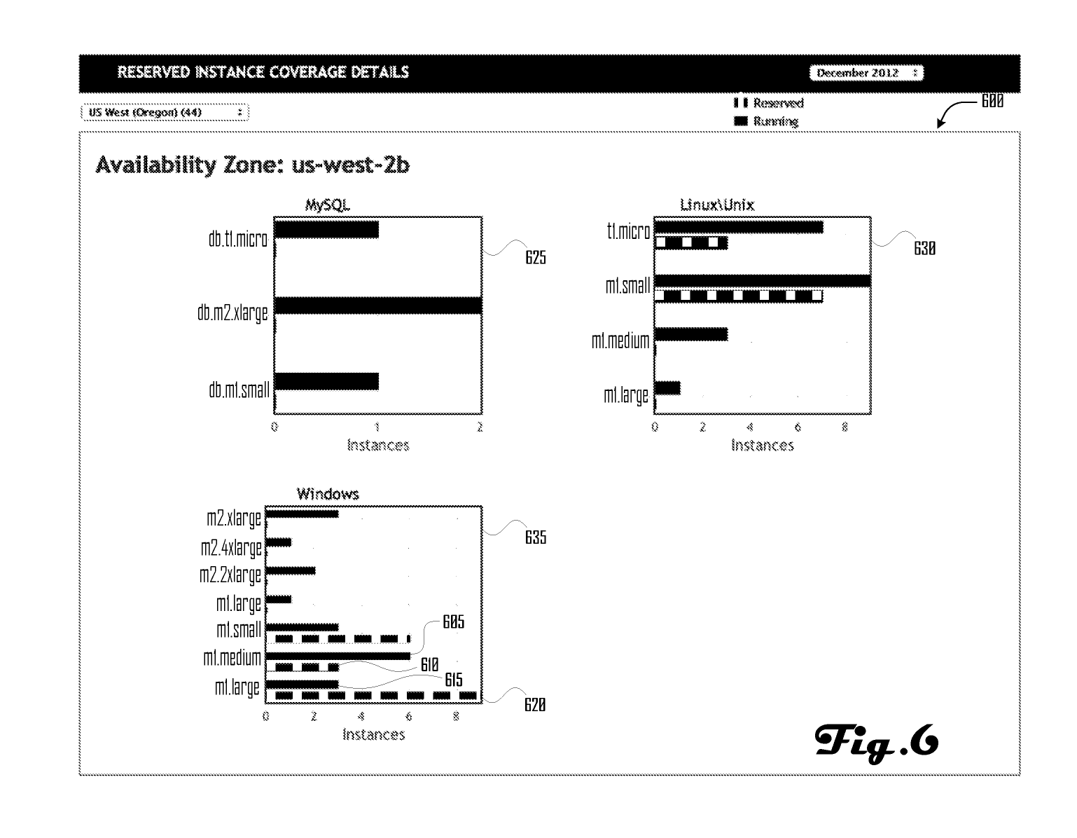

FIG. 6 illustrates an exemplary report 600 comparing total usage of various computing commodities with discount entitlements associated with the various computing commodities, in accordance with one embodiment. For example, chart 625 shows that one “t1.micro” size database commodity non-reserved instance, two “m2.xlarge” database commodity non-reserved instances, and one “m1.small” database commodity non-reserved instance were active for a given entity in the “us-west-2b” geographic availability zone during the December 2012 billing period.

Similarly, chart 630 shows, among other things, that seven non-reserved “t1.micro” computing instances were active in a first operating system during the December 2012 billing period and that the entity had reserved three such computing instances during that period.

Chart 635 shows similar total-running-instances vs. reserved computing instances in various sizes that were active in a second operating system during the December 2012 billing period. More specifically, bar 605 shows that during the December 2012 billing period, an entity ran six non-reserved “m1.medium” computing instances, and bar 610 shows the entity had three reserved instances available during the period. Similarly, bar 615 shows that during the billing period, the entity ran three “m1.large” instances, but that the entity had nine such reserved instances available. Thus, chart 635 illustrates a scenario in which the entity is running standard-rate “medium”-size instances in the same operating system and availability zone in which it has five under-utilized “large”-size reserved instances. Thus chart 635 shows (at least by implication) that if the entity's usage pattern is similar in the months following the illustrated billing period, then it may actually be less expensive to re-provision some of the “medium”-sized computing commodities to take advantage of the “large”-sized reserved instances. As discussed above, such a switch would be regarded as an “immaterial” modification because moving to a more capable, but otherwise identical instance is unlikely to materially hinder the operation of the service in question.

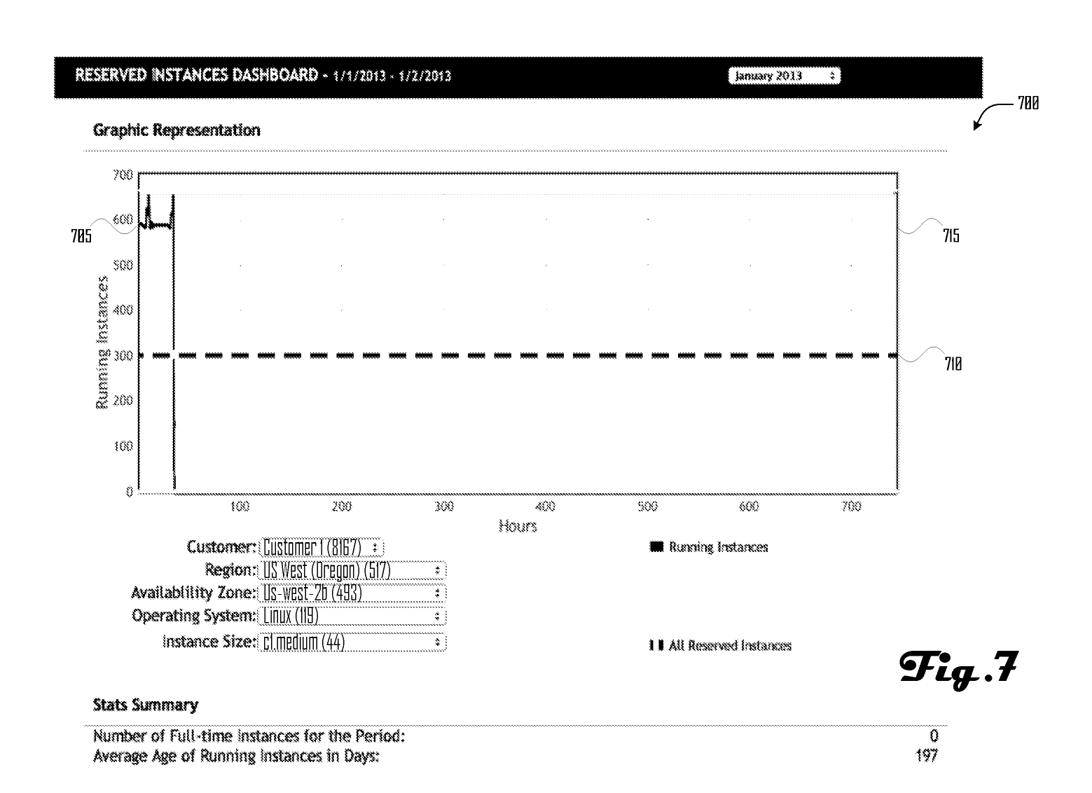

FIG. 7 illustrates an exemplary report 700 comparing actual usage of a computing commodity with discount entitlements associated with the computing commodity, in accordance with one embodiment. More specifically, line 705 of chart 715 shows that during the first approximately 35 hours of the January 2013 billing period, “Customer 1” ran approximately 600-650 instances of “c1.medium” size computing commodities, and that after approximately 35 hours, the entity shut down all of those instances and did not run any more for the rest of the month. Line 710 shows that during the entire January 2013 billing period, “Customer 1” was entitled to 300 reserved instances. Thus, chart 715 shows that for approximately 700 hours during the January 2013 billing period, the entity was not utilizing its discount entitlements in the indicated operating system, availability zone, and instance size. In other words, the un-utilized discount entitlements may be considered to be “spoiled” during the indicated time periods.

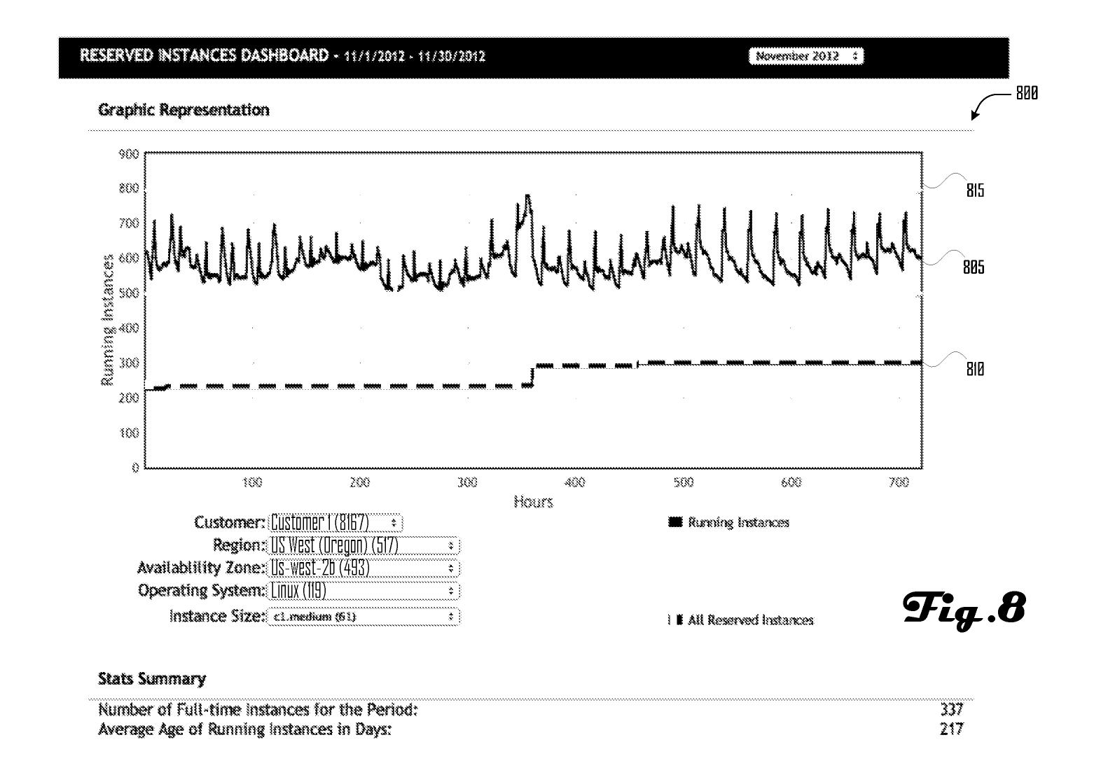

FIG. 8 illustrates an exemplary report 800 comparing actual usage of a computing commodity with discount entitlements associated with the computing commodity, in accordance with one embodiment. More specifically, line 805 of chart 815 shows that during the 720 hourly billing increments of the November 2012 billing period, “Customer 1” ran a varying number of approximately 550-750 instances of “c1.medium”-size computing commodities. Line 810 shows that “Customer 1” acquired a number of reserved instances during that billing period. Thus, chart 815 shows that during the billing period in question, the entity may have benefitted from having access to additional discount entitlements.

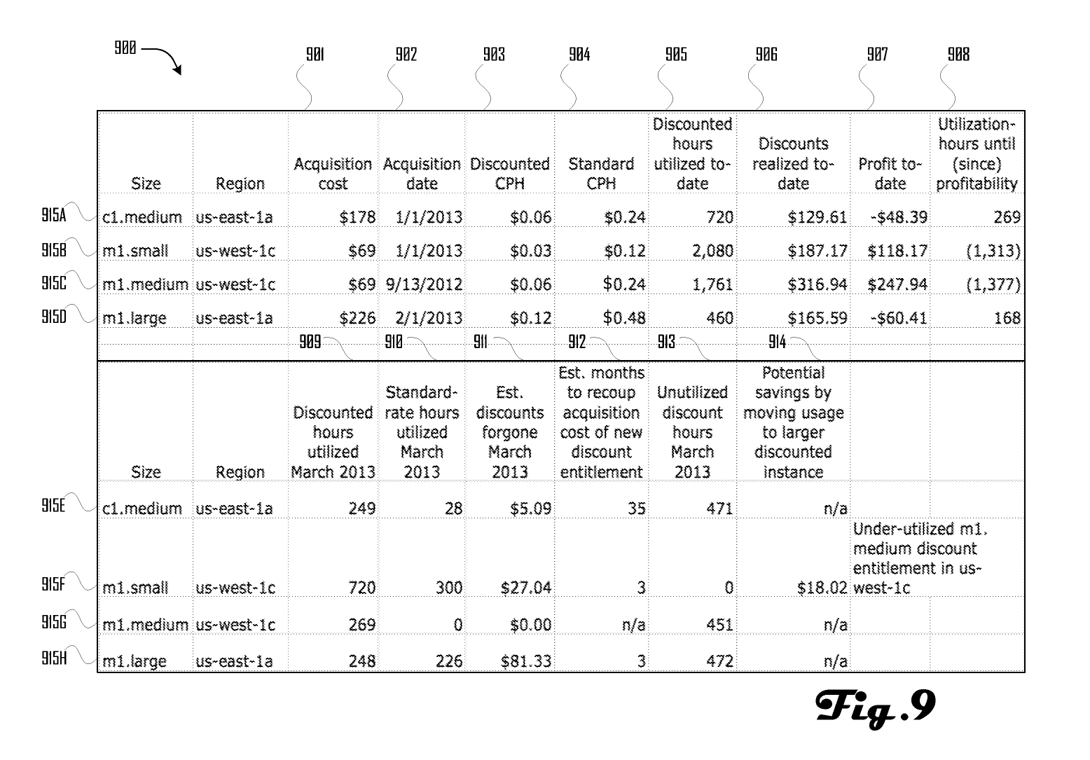

FIG. 9 illustrates an exemplary report 900 showing several statistics associated with computing commodity usage for a given entity, in accordance with one embodiment. More specifically, rows 915A-D show various statistics associated with four reserved instances that the entity is entitled to. It is assumed that these reserved instances all operate the same operating system.
Row 915A show statistics associated with one “medium”-sized reserved instance in region “us-east-1a” (hereinafter the “medium-east” reserved instance);
Row 915B shows statistics associated with one “small”-sized reserved instance in region “us-west-1c” (hereinafter the “small-west” reserved instance);
Row 915C shows statistics associated with one “medium”-sized reserved instance in region “us-west-1c” (hereinafter the “medium-west” reserved instance); and
Row 915D show statistics associated with one “large”-sized reserved instance in region “us-east-1a” (hereinafter the “large-east” reserved instance).

Columns 901 and 902 show acquisition costs and the dates on which the reserved instances were acquired. Column 903 shows the discounted billing rates (per hour) that the entity is entitled to for commodity usage on the various reserved instances.

Column 904 shows the standard (non-discounted) billing rates (per hour) that the entity is entitled to for its commodity usage in the same class as the various reserved instances. In some embodiments, such “standard” rates may vary according to usage-based tiers, and thus the standard billing rates may have been determined based on how much of a given quantity the entity consumed per billing period. For explanatory purposes, it is assumed that the entity's commodity usage remains roughly the same from billing period to billing period.

Column 905 shows the total, accumulated quantity of billing increments (here, hours) during which the entity has used its various reserved instances from its acquisition date through the reporting date (here, through the end of March 2013). Column 906 shows the total, accumulated dollar amount that use of each reserved instance has saved the entity from its acquisition date through the reporting date. In one embodiment, column 906 may be computed as the product of column 905 and the difference of columns 904 and 903.

Column 907 shows a dollar figure that represents the return on investment or “profit” that the reserved instance has provided since its acquisition. In cases where a given reserved instance has provided a lower realized discount than its acquisition cost, the reserved instance's “profit” is shown as a negative number. In the illustrated report 900, column 907 is computed as the simple difference between columns 901 and 906. As with all computations illustrated in report 900, in other embodiments, a reserved instance's “profit” may be computed according to a different and/or more complex formula.

Column 908 shows quantities representing either the number of additional billing increments (here, hours) that the reserved instances must be utilized before they will become “profitable” (as discussed above) or the number of billing increments that the reserved instances have been utilized since they became “profitable”. In the illustrated report 900, column 908 is computed as the quotient of column 907 and the difference of columns 903 and 904.

Rows 915E-H refer respectively to the same reserved instances as rows 915A-D and show additional statistics related to the current billing period (here, March 2013).

Column 909 shows the quantity of billing increments (here, hours) in which the entity has used its various reserved instances during the current billing period. Column 910 shows the quantity of billing increments (here, hours) during the current billing period in which the entity ran a non-reserved instance (which was billed at a standard rate) in the same classification as one of its reserved instances. Column 911 shows a dollar figure representing estimates of potential discounts that the entity forwent or did not realize because it did not have a reserved instance available for the commodity usage reflected in column 910. In the illustrated report 900, column 911 is computed as the product of column 910 and the difference of columns 904 and 903.

Column 912 shows quantities that represent an estimated number of billing periods (here, months) that it would take to realize savings equal to the acquisition cost of a hypothetical new reserved instance in a given class of commodity usage, based on the entity's usage during the current billing period. In the illustrated report 900, column 912 is computed as the quotient of columns 901 and 911. For example, report 900 shows that the entity ran non-reserved “large”-sized instances in the “us-east-1a” region for 226 hours (billed at standard rates) during the current billing period. If the entity expects similar usage patterns in the following billing periods, column 912 or row 915H of report 900 shows that the entity may be able to recoup the cost of acquiring a new large-east reserved instance within three months. In some embodiments, a months-to-recoup quantity below a predetermined threshold (e.g., 1-6 months) may constitute a recommendation to acquire an additional reserved instance for a given class of commodity usage.

Column 913 shows quantities that represent reserved instance “spoilage” or billing increments (here, hours) during which the entity was not running a reserved instance and was therefore not capturing any savings based on its investment to acquire its various reserved instances. In report 900, column 913 is computed as a difference of the number of billing increments (here, hours) in the current billing period and column 909.

Column 914 shows potential savings that, given similar future usage patterns, the entity may be able to capture by switching standard-rate commodity usage (provisioned in one class of commodity service) to a currently underutilized reserved instance in a class of service that is more capable than, but otherwise identical to, the currently provisioned class of commodity service.

For example, report 900 shows that in March 2013, the entity had one small-west reserved instance and one medium-west reserved instance. The entity ran non-reserved instances for 300 hours in the same class as the small-west reserved instance, and the entity had 451 hours during which the medium-west reserved instance was unutilized. Because the medium-west class of service is more capable than, but otherwise identical to the small-west class of service (both of which are assumed to run the same operating system), switching commodity usage from the small-west class of service would not materially impair the functionality provided by the commodity usage. Assuming that future usage patterns are similar to current usage patterns, column 914 shows that making such an immaterial modification could result in lower costs because the discounted billing rate for a medium-west reserved instance is lower than the standard billing rate for a small-west non-reserved instance. In some embodiments, quantities in column 914 that are higher than a predetermined threshold may be considered to be a recommendation to re-provision commodity usage from a less capable class of service to a more-capable, but otherwise identical, class of service, such a re-provisioning being an immaterial modification to the commodity usage.

Although specific embodiments have been illustrated and described herein, it will be appreciated by those of ordinary skill in the art that a whole variety of alternate and/or equivalent implementations may be substituted for the specific embodiments shown and described without departing from the scope of the present disclosure. This application is intended to cover any such adaptations or variations of the embodiments discussed herein.

1. A rebilling-server-implemented method for unconsolidating a consolidated bill for commodity computing services provided by a commodity-computing-services provider during a billing period, the method comprising:
obtaining, by the rebilling server from the commodity-computing-services provider, the consolidated bill;
identifying, by the rebilling server, a plurality of entities that were billed at a blended billing rate determined based at least in part on aggregate usage of a computing commodity by said identified plurality of entities, and further based at least in part on a plurality of term-based discount entitlements associated with one or more of said identified plurality of entities;
selecting, by the rebilling server, one of said identified plurality of entities as being individually associated with one or more entity-specific term-based discount entitlements;
obtaining, by the rebilling server, periodic usage statistics corresponding to computing-commodity usage specific to said selected entity during the billing period;
determining, by the rebilling server based at least in part on said computing-commodity usage statistics and said one or more entity-specific term-based discount entitlements, a discounted billing rate specific to at least some of said entity-specific computing-commodity usage;
determining, by the rebilling server based at least in part on said computing-commodity usage statistics, a standard billing rate applicable to some or all of said entity-specific computing-commodity usage to which said one or more entity-specific term-based discount entitlements does not apply;
computing, by the rebilling server based at least in part on said entity-specific discounted billing rate, said standard billing rate, and said computing-commodity usage statistics, an unblended entity-specific cost corresponding to said entity-specific computing-commodity usage; and
storing, by the rebilling server, said unblended entity-specific cost in association with said selected entity.

2. The method of claim 1, wherein obtaining said computing-commodity usage statistics corresponding to said entity-specific computing-commodity usage comprises:
determining a plurality of total-usage statistics corresponding respectively to a plurality of billing increments during the billing period, each total-usage statistic indicating usage of said computing commodity during one of said plurality of billing increments without regard to said one or more entity-specific term-based discount entitlements; and
determining a plurality of discount-usage statistics corresponding respectively to said plurality of billing increments, each discount-usage statistic indicating discounted usage of said computing commodity during one of said plurality of billing increments according to one or more of said one or more entity-specific term-based discount entitlements.

3. The method of claim 2, further comprising providing for presentation to a user a graphical representation depicting said plurality of total-usage statistics and said plurality of discount-usage statistics over time throughout the billing period.

4. The method of claim 2, further comprising identifying, based at least in part on said plurality of total-usage statistics and said plurality of discount-usage statistics, a plurality of billing increments during which one or more of said plurality of term-based discount entitlements were un-utilized by said selected entity.

5. The method of claim 4, further comprising identifying, according to said computing-commodity usage statistics, computing-commodity usage by said selected entity that was billed at said standard billing rate, but that with an immaterial modification could have been billed at said entity-specific discounted billing rate according to an un-utilized term-based discount entitlement.

6. The method of claim 5, further comprising providing for presentation to a user a report indicating said immaterial modification as a potential cost-saving measure.

7. The method of claim 2, further comprising identifying, based at least in part on said plurality of total-usage statistics and said plurality of discount-usage statistics, a plurality of billing increments during which at least one additional term-based discount entitlement would have been utilized had it been available to said selected entity.

8. The method of claim 7, further comprising computing a forgone-discounts statistic indicating potential cost savings that were forgone because said at least one additional term-based discount entitlement was not available to said selected entity.

9. The method of claim 8, further comprising:
determining an acquisition cost associated with acquiring said at least one additional term-based discount entitlement; and
determining a recommendation to acquire said at least one additional term-based discount entitlement based at least in part on a comparison of said forgone-discounts statistic and said acquisition cost.

10. The method of claim 9, further comprising providing said recommendation for presentation to a user.

11. The method of claim 9, further comprising automatically acquiring said at least one additional term-based discount entitlement.

12. The method of claim 1, wherein obtaining said computing-commodity usage statistics corresponding to said entity-specific computing-commodity usage comprises determining one or more current-period savings statistics corresponding respectively to said one or more entity-specific term-based discount entitlements, each current-period savings statistic indicating a difference between said standard billing rate and said entity-specific discounted billing rate as applied to said at least some of said entity-specific computing-commodity usage during the billing period.

13. The method of claim 12, further comprising updating, according to said one or more current-period savings statistics, one or more inception-to-date savings statistics corresponding respectively to said one or more entity-specific term-based discount entitlements.

14. The method of claim 13, further comprising:
determining one or more entitlement-acquisition costs corresponding respectively to said one or more entity-specific term-based discount entitlements;
determining whether any of said one or more inception-to-date savings statistics exceed a corresponding one of said one or more entitlement-acquisition costs; and
when one of said one or more inception-to-date savings statistics is determined to exceed an entitlement-acquisition cost corresponding to a determined one of said one or more entity-specific term-based discount entitlements, storing an indication that said determined term-based discount entitlement is profitable.

15. The method of claim 14, further comprising providing for presentation to a user a report distinguishing between term-based discount entitlements that have been determined to be profitable and those that have not been determined to be profitable.

16. A computing apparatus comprising a processor and a memory having stored thereon instructions that when executed by the processor, configure the apparatus to perform a method for unconsolidating a consolidated bill for commodity computing services provided by a commodity-computing-services provider during a billing period, the method comprising:
obtaining, from the commodity-computing-services provider, the consolidated bill;
identifying a plurality of entities that were billed at a blended billing rate determined based at least in part on aggregate usage of a computing commodity by said identified plurality of entities, and further based at least in part on a plurality of term-based discount entitlements associated with one or more of said identified plurality of entities;
selecting one of said identified plurality of entities as being individually associated with one or more entity-specific term-based discount entitlements;
obtaining periodic usage statistics corresponding to computing-commodity usage specific to said selected entity during the billing period;
determining, based at least in part on said computing-commodity usage statistics and said one or more entity-specific term-based discount entitlements, a discounted billing rate specific to at least some of said entity-specific computing-commodity usage;
determining, based at least in part on said computing-commodity usage statistics, a standard billing rate applicable to some or all of said entity-specific computing-commodity usage to which said one or more entity-specific term-based discount entitlements does not apply;
computing, based at least in part on said entity-specific discounted billing rate, said standard billing rate, and said computing-commodity usage statistics, an unblended entity-specific cost corresponding to said entity-specific computing-commodity usage; and
storing said unblended entity-specific cost in association with said selected entity.

17. The apparatus of claim 16, wherein obtaining said computing-commodity usage statistics corresponding to said entity-specific computing-commodity usage comprises:
determining a plurality of total-usage statistics corresponding respectively to a plurality of billing increments during the billing period, each total-usage statistic indicating usage of said computing commodity during one of said plurality of billing increments without regard to said one or more entity-specific term-based discount entitlements; and
determining a plurality of discount-usage statistics corresponding respectively to said plurality of billing increments, each discount-usage statistic indicating discounted usage of said computing commodity during one of said plurality of billing increments according to one or more of said one or more entity-specific term-based discount entitlements.

18. The apparatus of claim 17, the method further comprising providing for presentation to a user a graphical representation depicting said plurality of total-usage statistics and said plurality of discount-usage statistics over time throughout the billing period.

19. A non-transient computer-readable storage medium having stored thereon instructions that when executed by a processor, configure the processor to perform a method for unconsolidating a consolidated bill for commodity computing services provided by a commodity-computing-services provider during a billing period, the method comprising:
obtaining, from the commodity-computing-services provider, the consolidated bill;
identifying a plurality of entities that were billed at a blended billing rate determined based at least in part on aggregate usage of a computing commodity by said identified plurality of entities, and further based at least in part on a plurality of term-based discount entitlements associated with one or more of said identified plurality of entities;
selecting one of said identified plurality of entities as being individually associated with one or more entity-specific term-based discount entitlements;
obtaining periodic usage statistics corresponding to computing-commodity usage specific to said selected entity during the billing period;
determining, based at least in part on said computing-commodity usage statistics and said one or more entity-specific term-based discount entitlements, a discounted billing rate specific to at least some of said entity-specific computing-commodity usage;
determining, based at least in part on said computing-commodity usage statistics, a standard billing rate applicable to some or all of said entity-specific computing-commodity usage to which said one or more entity-specific term-based discount entitlements does not apply;
computing, based at least in part on said entity-specific discounted billing rate, said standard billing rate, and said computing-commodity usage statistics, an unblended entity-specific cost corresponding to said entity-specific computing-commodity usage; and
storing said unblended entity-specific cost in association with said selected entity.

20. The storage medium of claim 19, wherein obtaining said computing-commodity usage statistics corresponding to said entity-specific computing-commodity usage comprises:
determining a plurality of total-usage statistics corresponding respectively to a plurality of billing increments during the billing period, each total-usage statistic indicating usage of said computing commodity during one of said plurality of billing increments without regard to said one or more entity-specific term-based discount entitlements; and
determining a plurality of discount-usage statistics corresponding respectively to said plurality of billing increments, each discount-usage statistic indicating discounted usage of said computing commodity during one of said plurality of billing increments according to one or more of said one or more entity-specific term-based discount entitlements.

21. The storage medium of claim 20, the method further comprising providing for presentation to a user a graphical representation depicting said plurality of total-usage statistics and said plurality of discount-usage statistics over time throughout the billing period.
